(19) United States
(12) Patent Application Publication
(10) Pub. No.: US 2025/0387774 A1
(43) Pub. Date: Dec. 25, 2025

(54) LITHIUM ZIRCONATE ENHANCED COMPOSITIONS FOR INCREASED REACTION KINETICS OF CO2 CHEMISORPTION/DESORPTION AT HIGH TEMPERATURE

(71) Applicant: Valero Services, Inc., San Antonio, TX (US)

(72) Inventors: Jason Daniel Herrera, San Antonio, TX (US); Michael A. Miller, Helotes, TX (US); Michael J. Rubal, Lytle, TX (US)

(21) Appl. No.: 18/750,870

(22) Filed: Jun. 21, 2024

(51) Int. Cl. B01J 20/04; B01D 53/14; B01D 53/62

(52) U.S. Cl. CPC B01J 20/041; B01D 53/1475; B01D 53/62; B01D 2252/10; B01D 2257/504; B01D 2258/0283; B01J 2220/42

(57) ABSTRACT

Solid-state membrane compositions for separating carbon dioxide gas from mixed gases such as exhaust or flue gases from combusted hydrocarbon are described, where in an embodiment the composition comprises zirconyl (IV) nitrate; a lithium nitrate; a copper (II) nitrate, and a potassium nitrate. Methods for forming such copper infused lithium zirconate membrane for separating carbon dioxide gas showing enhanced absorption and desorption of CO₂ gas are also described.

### TECHNICAL FIELD

The disclosure relates to copper infused lithium zirconate compositions for separating carbon dioxide from gas mixtures in a high temperature effluent. The disclosure also provides methods of synthesizing the copper infused lithium zirconate compositions.

### BACKGROUND

A solid-state membrane has several challenging problems including manufacturability of mechanically robust membranes, long-term stability and durability of the material, resistance to impurities, and the cost of manufacturing and maintaining such membranes.

There remains a need for a solid-state membrane that overcomes the challenges and allows separation of CO₂ from gas mixtures from an effluent conditions.

### BRIEF SUMMARY

In brief, the present disclosure provides compositions for separating carbon dioxide gas. In one embodiment, a method of forming a lithium zirconate (LZO) membrane for separating carbon dioxide gas is provided. In one embodiment, a method of separating carbon dioxide gas is disclosed.

Various aspects and embodiments now will be described more fully hereinafter. Such aspects and embodiments may take many different forms and the exemplary ones disclosed herein should not be construed as limiting; rather, these embodiments are provided so that this disclosure will be thorough and complete, and will fully convey its scope to those skilled in the art.

### BRIEF DESCRIPTION OF THE DRAWINGS

FIG. 1 is a Raman Spectrum of copper-doped LZO (Cu-LZO) compared with pure LZO, showing shift in the peak position of the characteristic stretching frequency for Zr—O lattice bonds to slightly lower frequencies (vertical dotted line positioned at 576.72 cm⁻¹) due to copper substitution.

FIG. 2 is X-Ray Diffraction Spectrum of Cu-LZO compared with LZO, showing shifts in characteristic reflections due to copper substitution.

FIG. 3 is a TGA plot of LZO (sol-gel).

FIG. 4 is a plot of absorption rate constants versus temperature of copper additive only and Cu-LZO materials.

FIG. 5 is a plot of desorption rate constants versus temperature of copper additive only and Cu-LZO materials.

FIG. 6 is a plot of absorption rate constants versus temperature for Cu-LZO materials.

FIG. 7 is a plot of desorption rate constants versus temperature for Cu-LZO materials.

FIG. 8 is a plot of absorption rate constants versus temperature for Cu-LZO materials with various copper contents.

FIG. 9 is a plot of desorption rate constants versus temperature for Cu-LZO materials with various copper contents.

FIG. 10 is a plot of flux rate of Cu-LZO vs LZO (sol-gel).

### DETAILED DESCRIPTION

### I. Definitions

For convenience, certain terms employed in the specification, examples and claims are collected here. Unless defined otherwise, all technical and scientific terms used in this disclosure have the same meanings as commonly understood by one of ordinary skill in the art to which this disclosure belongs.

The singular forms “a,” “an,” and “the” include plural referents unless the context clearly dictates otherwise. Thus, for example, reference to a “polymer” includes a single polymer as well as two or more of the same or different polymers, reference to an “excipient” includes a single excipient as well as two or more of the same or different excipients, and the like.

The term “about”, particularly in reference to a given quantity, is meant to encompass deviations of plus or minus five percent.

The term “effluent” refers to gaseous emissions containing carbon dioxide (CO₂) among other gaseous molecules. Effluent may result from industrial processes (including, but not limited to, power generation, refining, petrochemical manufacturing, steel manufacturing, cement manufacturing) or from the combustion of carbon-based fuels in internal combustion engines.

The phrase “separating carbon dioxide gas” means that through the composition or the lithium zirconium membrane disclosed in the present disclosure carbon dioxide gas (CO₂) is selectively absorbed and desorbed such that CO₂ is the primary gas from an initial mixture of gases that passes through the composition or the lithium zirconium membrane.

The compositions of the present disclosure can comprise, consist essentially of, or consist of, the components disclosed.

All percentages, parts and ratios are based upon the total weight of the compositions and all measurements made are at about 25° C., unless otherwise specified.

By reserving the right to proviso out or exclude any individual members of any such group, including any sub-ranges or combinations of sub-ranges within the group, that can be claimed according to a range or in any similar manner, less than the full measure of this disclosure can be claimed for any reason.

Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

### II Compositions

Improved absorption rates for LZO materials, particularly at lower temperatures, are observed by use of an additional counterion such as potassium (K⁺) that, along with lithium ions, forms a carbonate eutectic mixture of Li₂CO₃/K₂CO₃ during the absorption reaction. This improvement arises from the formation of a eutectic molten carbonate layer that increases the diffusion rate of CO₂ to and from a mixed solid core of the reactant (LZO) and zirconia (ZrO₂). The potassium modified lithium zirconate (K-LZO) is prepared, in a first step, by dissolving the complementary metal nitrate salts of potassium, lithium, and zirconium in a suitable solvent system at the appropriate molar ratios to produce a pre-cursor solution. In a second step, the solution is dried and calcined to form solid K-LZO.

Further improvements in absorption rates are realized by doping K-LZO with copper ions (Cu²⁺), starting from the above-mentioned pre-cursor solution and adding the corresponding copper nitrate salt. Similar benefits can also be gained by doping LZO with copper ions, omitting the potassium nitrate salt from the above-mentioned precursor solution. During calcination in either case, some of the Zr atoms in the crystal structure of LZO or K-LZO are substituted with copper atoms. Such atomic substitutions may also be referred to as “copper infusion” or “copper-doped LZO” in the present disclosure.

Preparation of the composition is described. Into a solvent compatible container, a weighed amount of each starting materials is added:
1. ZrO(NO₃)₂·H₂O zirconyl (IV) nitrate
2. LiNO₃ lithium nitrate
3. KNO₃ potassium nitrate
4. Cu(NO₃)₂ copper (II) nitrate

To the container, 100 to 500 mL of ethanol (100%) is added. The mixture is stirred slowly for 5 to 10 minutes to dissolve the solids. Once the material is completely mixed, the solution is then blended by mechanical means until the solution becomes clear an no solid particulates are present.

The clear solution is poured into a porcelain or quartz dish. The container is placed in an oven set to 70° C. until dry. Once dry, the pre-cursor material is calcined to 700 to 900° C. in a programmable oven under an atmosphere of air. The oven is set with a ramp rate of 10° C./min and held at final temperature for 0.5 to 3.0 hours. Allow the material to cool in the oven.

Further, the addition of copper in this formulation is prepared using the solid calcinated potassium-modified LZO which contains no initial copper. The potassium-modified LZO is prepared using:
1. ZrO(NO₃)₂·H₂O zirconyl (IV) nitrate
2. LiNO₃ lithium nitrate
3. KNO₃ potassium nitrate

The solid potassium-modified LZO is ground using a mortar and pestle and then placed suitably sized vial. To the vial a measured amount of a 0.001 to 0.5 molar solution of Cu(NO₃)₂, prepared in ethanol, is added. The vial is then agitated to ensure complete coverage of the solid material with the solution. The mixed material is poured out of the vial into a porcelain dish. The container is placed in an oven set to 70° C. until dry. Once dry, the pre-cursor material is calcined to 700 to 900° C. in a programmable oven under an atmosphere of air. The oven is set with a ramp rate of 10° C./min and held at final temperature for 0.5 to 3.0 hours. Allow the material to cool in the oven.

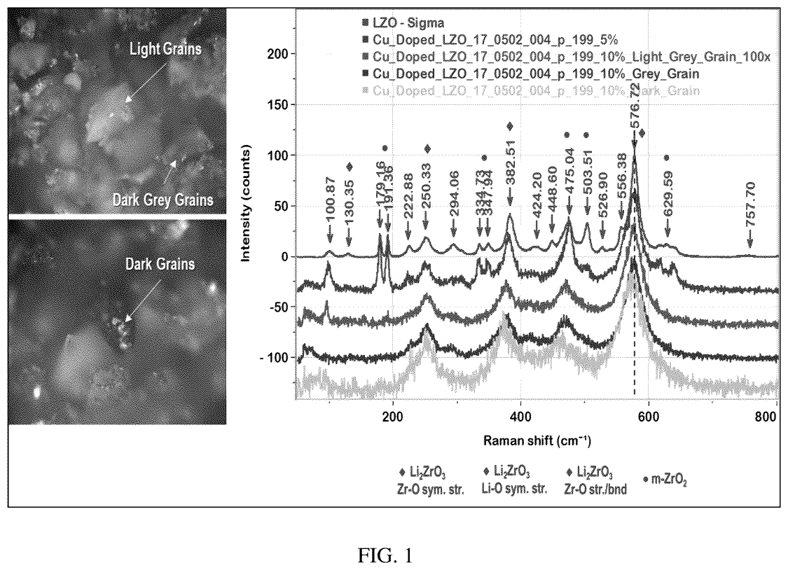

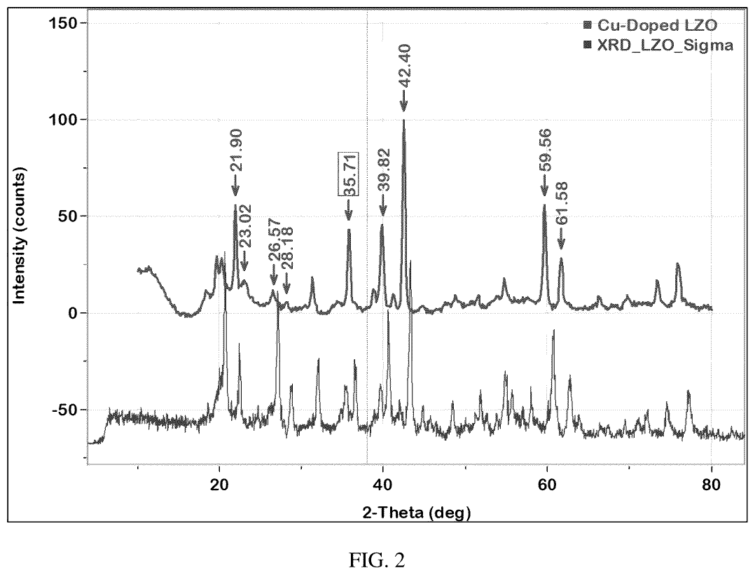

Raman spectrum of copper infused LZO was compared with LZO in FIG. 1. X-ray diffraction spectrum of copper infused LZO was compared with LZO in FIG. 2.

### Calculation of CO₂ Absorption and Desorption

### Thermal Gravimetric Analysis (TGA) of Samples

To measure and compare the absorption and desorption constants for the various LZO formulations samples were analyzed by TGA. The following is provided as an example of the TGA parameters used for samples of ˜30 mg of LZO is placed within an alumina or platinum cup which was then placed within the TGA.

| Parameters | Purge Gas |
|---|---|
| 1) Ramp to 900° C. at 20° C./min | CO2 |
| 2) Equilibrate to 25° C. | CO2 |
| 3) Ramp to 600° C. at 20° C./min | CO2 |
| 4) Isotherm for 2 h | CO2 |
| 5) Isotherm for 2 h | N2 |

Repeat steps 3-5 for elevated temperatures

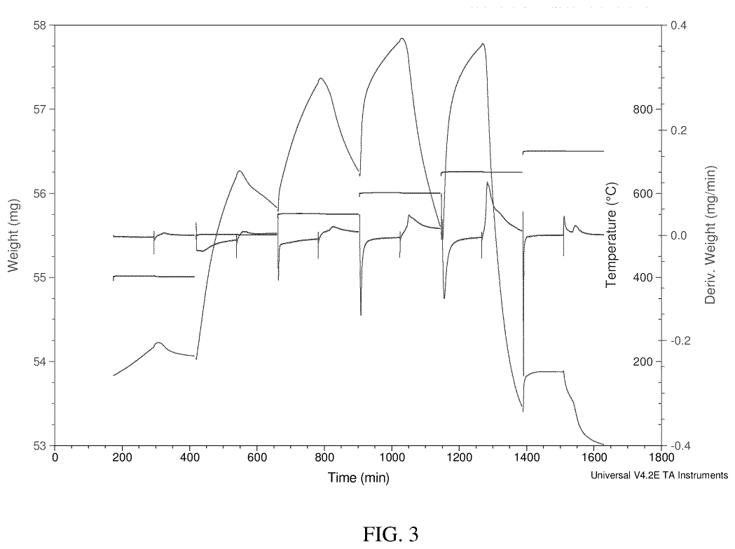

Using the parameters described above, the overlay plot in FIG. 3, was prepared from the analysis of a sol-gel LZO formulation. Within FIG. 3, the weight versus time, the derivative of weight versus time, and the temperature versus time was plotted. Data extracted from this plot for the means of measuring the rate constants includes the maximum rates in mg/min and mass in mg at those maximums for each isothermal step. In addition, a total minimum mass of the LZO is defined here as the mass of the sample at the end of the isotherm at 700° C. in nitrogen for 2 h.

Absorption and desorption of CO₂ with lithium zirconate is shown in the mechanism of equation (I) below.

$${Li}_{2} {ZrO}_{3} ( s ) + {CO}_{2} ( g ) {{⇄}_{{k}_{d}}}^{{k}_{a}} {Li}_{2} {CO}_{3} ( s ) + {ZrO}_{2} ( s ) \qquad ( I )$$

Equation (I). Equilibrium reaction of LZO and carbon dioxide to form lithium carbonate and zirconium oxide and vice versa.

The mechanism associated with carbon dioxide (CO₂) absorption and desorption for LZO is shown in Equation (1), where the rate constant for CO₂ absorption by LZO is kₐ and the rate constant for desorption from the zirconium oxide/carbonate form is k_{d}.

To simplify the calculation of rate constants some assumptions were made such as: Formulations of LZO can vary considerably and contain inactive forms of carbonates and ZrO₂. The only thing that is relevant are active forms of LZO and active combination of Li₂CO₃ and ZrO₂. Therefore, equation (I) can be rewritten as shown in equation (II) where;
M=mol fraction of active sites (LZO) that can absorb CO₂
M-CO₂=mol fraction of occupied sites (Li₂CO₃+ZrO₂) that can release CO₂

Finally, when the purge gas is 100% CO₂, one can eliminate the dependency on the CO₂ concentration (or at least contingent to the concentration and pressure of CO₂ during the study), and, therefore, consider this process of absorption and desorption as a 1st order process with respect to mol fraction of active sites (LZO) for absorption and mol fraction of occupied sites (Li₂CO₃+ZrO₂) for desorption.

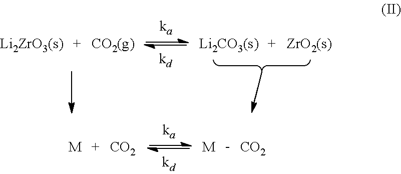

To calculate the rate constants for the LZO formulations the equations and assumptions shown in equation (III) were implemented. It should be noted that the calculation for maximum expected weight for a sample may vary depending on the formulation.

| | |
|---|---|
| 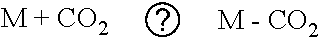 | Minimum mass ( [symbol] ) = mass after 2 h at 700° C. under N₂ |
| | Let mass [symbol] be 100% weight |
| | The calculated maximum weight % = 122.4% |
| | (based on LZO sol-gel method) [symbol] × 1.224 |
| Rate [symbol] = kₐ [M] [CO₂] | |
| Rate [symbol] = k_{d} [M − CO₂] | At time point t: |
| [symbol] = Rate [symbol] − Rate_{d} | $\text{?}$ |
| Isothermin 100 % CO₂: [CO₂] = 1 | Measured during Isotherm (N₂): |
| $\text{?}$ | $\text{?}$ |
| Isotherm in N₂: [CO₂] = 0 | Measure during Isotherm (CO₂): |
| Rate_{d} = [symbol] + 0 | $\text{?}$ |
| | RED = measured values from TGA plot |
| | BLUE = calculated values |

[symbol]

indicates data missing or illegible when filed

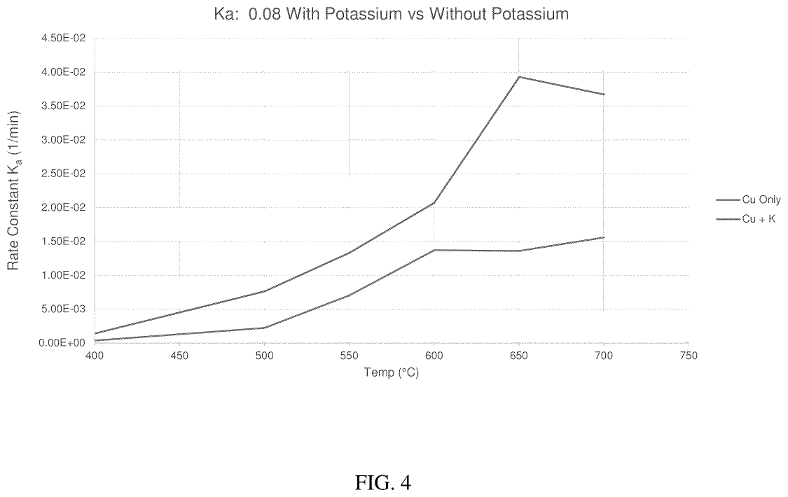

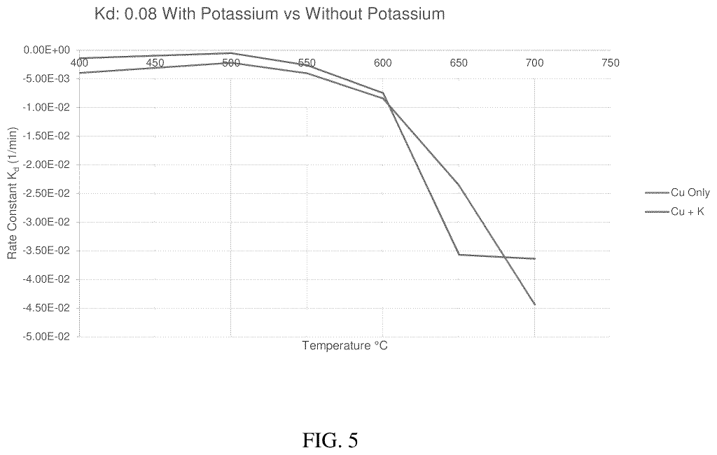

The calculated rate constants, measured from the TGA data, synthesized sol-gel formulation with copper only is compared with as sol-gel formulation prepared with copper additive and plotted in FIGS. 4-6.

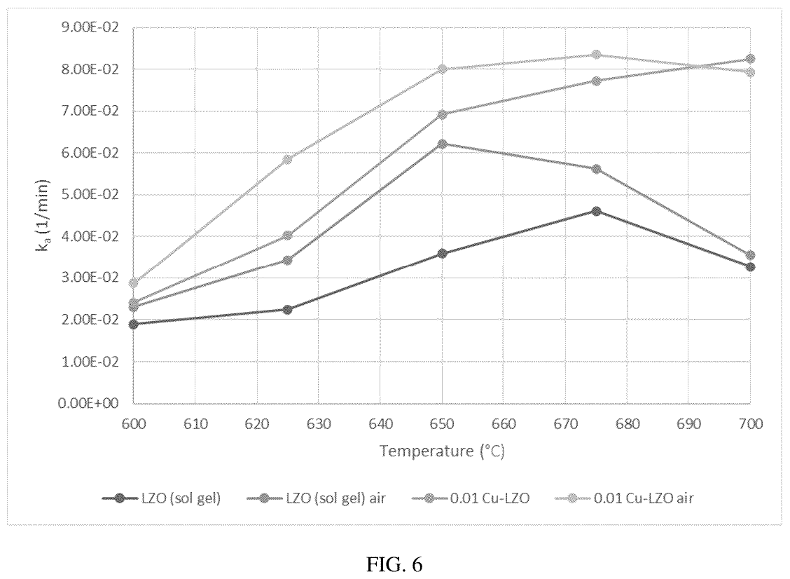

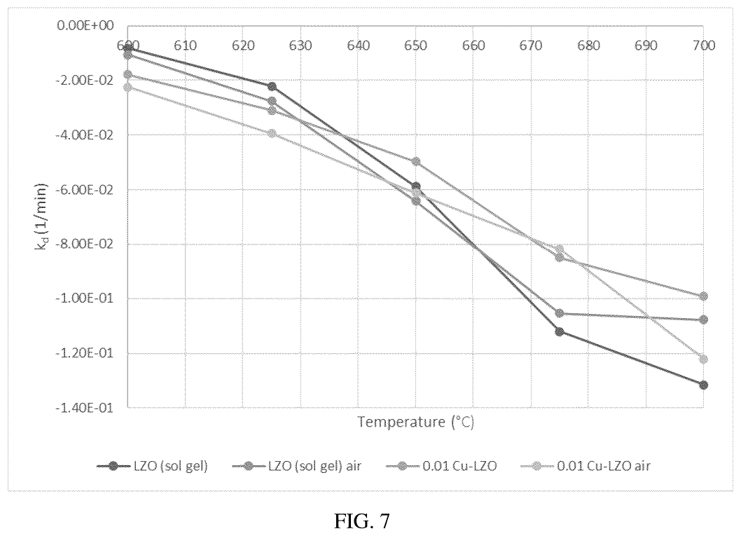

The calculated rate constants, measured from the TGA data, for synthesized sol-gel formulations are compared with sol-gel formulation that were prepared with copper additive within Tables 1-2 as well as plotted in FIGS. 6-7. Also included are the same formulations run in air, instead of nitrogen, purge during the desorption isotherms run on the TGA. It is interesting to note that neither this change in purge gas, nor a change in copper content, appeared to have any appreciable effect on the desorption rate constants. However, a noticeable enhancement was observed for the absorption rate constants for samples that were exposed to air during the desorption and those that contained copper.

TABLE 1
Absorption rate constants for LZO formulations run under nitrogen during
the desorption isotherm or run under air during the desorption isotherm.

| Temperature | kₐ (1/min) | | | |
|---|---|---|---|---|
| (° C.) | LZO (sol gel) | LZO (sol gel) air | 0.01 Cu-LZO | 0.01 Cu-LZO air |
| 600 | 1.89E−02 | 2.30E−02 | 2.40E−02 | 2.86E−02 |
| 625 | 2.24E−02 | 3.43E−02 | 4.02E−02 | 5.85E−02 |
| 650 | 3.59E−02 | 6.21E−02 | 6.91E−02 | 7.99E−02 |
| 675 | 4.61E−02 | 5.62E−02 | 7.72E−02 | 8.34E−02 |
| 700 | 3.27E−02 | 3.55E−02 | 8.25E−02 | 7.93E−02 |

TABLE 2
Desorption rate constants for LZO formulations run under nitrogen during
the desorption isotherm or run under air during the desorption isotherm.

| Temperature | kₐ (1/min) | | | |
|---|---|---|---|---|
| (° C.) | LZO (sol gel) | LZO (sol gel) air | 0.01 Cu-LZO | 0.01 Cu-LZO air |
| 600 | −8.24E−03 | −1.07E−02 | −1.79E−02 | −2.24E−02 |
| 625 | −2.21E−02 | −2.76E−02 | −3.11E−02 | −3.95E−02 |
| 650 | −5.89E−02 | −6.42E−02 | −4.98E−02 | −6.13E−02 |
| 675 | −1.12E−01 | −1.05E−01 | −8.51E−02 | −8.19E−02 |
| 700 | −1.32E−01 | −1.08E−01 | −9.93E−02 | −1.22E−01 |

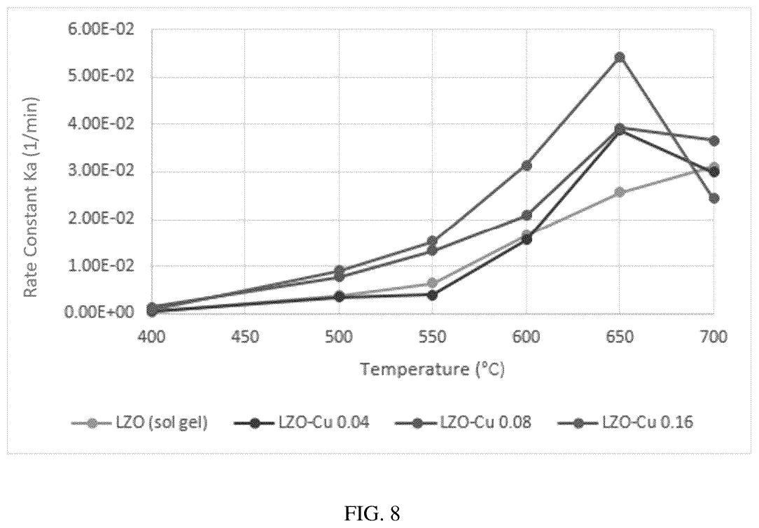

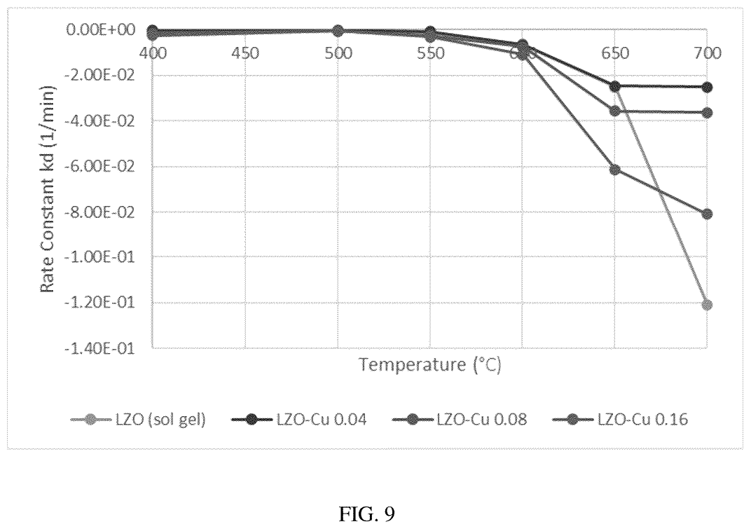

The calculated rate constants, measured from the TGA data, synthesized sol-gel formulations are compared with LZO with various copper amounts which is summarized in Tables 3-4 as well as plotted in FIGS. 8-9.

TABLE 3
Absorption rate constants for LZO formulations
with various copper amounts (1/min).

| Temp | | | | |
|---|---|---|---|---|
| ° C. | LZO (sol gel) | LZO-Cu 0.04 K | LZO-Cu 0.08 K | LZO-Cu 0.16 K |
| 400 | 3.92E−04 | 5.43E−04 | 1.40E−03 | 8.90E−04 |
| 500 | 3.78E−03 | 3.51E−03 | 7.62E−03 | 9.02E−03 |
| 550 | 6.37E−03 | 3.86E−03 | 1.33E−02 | 1.53E−02 |
| 600 | 1.99E−02 | 1.99E−02 | 1.92E−02 | 2.45E−02 |
| 625 | 2.24E−02 | 3.43E−02 | 3.04E−02 | 4.25E−02 |
| 650 | 3.59E−02 | 4.53E−02 | 4.30E−02 | 5.39E−02 |
| 675 | 4.61E−02 | 5.20E−02 | 3.53E−02 | 3.73E−02 |
| 700 | 3.27E−02 | 2.61E−02 | 5.16E−02 | 2.21E−02 |

TABLE 4
Desorption rate constants for LZO formulations
with various copper amounts (1/min).

| Temp | | | | |
|---|---|---|---|---|
| ° C. | LZO (sol gel) | LZO-Cu 0.04 K | LZO-Cu 0.08 K | LZO-Cu 0.16 K |
| 400 | −1.37E−04 | −2.07E−04 | −1.42E−03 | −2.61E−03 |
| 500 | −1.96E−04 | −1.99E−04 | −5.27E−04 | −5.86E−04 |
| 550 | −1.37E−03 | −7.96E−04 | −2.62E−03 | −3.13E−03 |
| 600 | −8.24E−03 | −7.50E−03 | −1.01E−02 | −1.38E−02 |
| 625 | −2.21E−02 | −1.53E−02 | −2.25E−02 | −3.79E−02 |
| 650 | −5.89E−02 | −2.78E−02 | −4.69E−02 | −7.24E−02 |
| 675 | −1.12E−01 | −3.72E−02 | −4.45E−02 | −7.61E−02 |
| 700 | −1.32E−01 | −2.25E−02 | −3.80E−02 | −6.58E−02 |

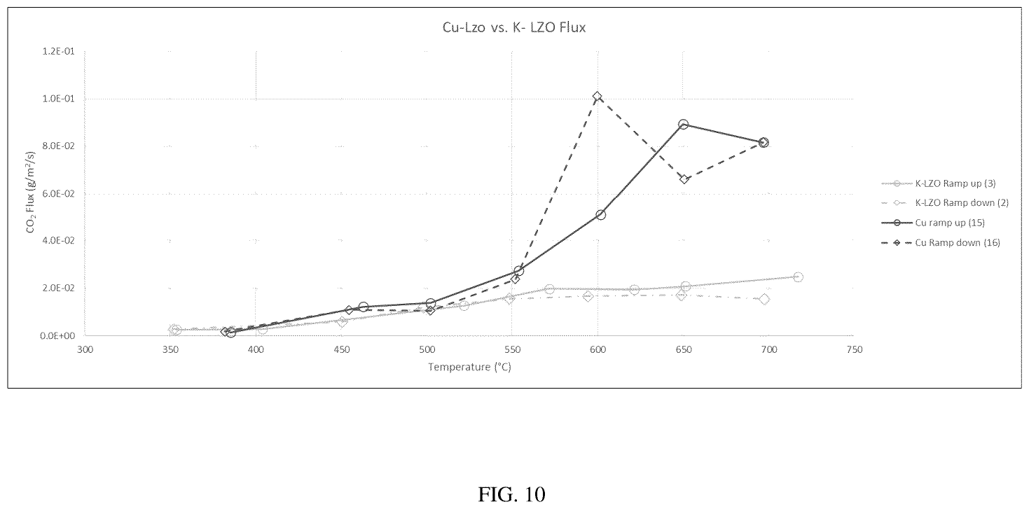

Now referring to FIG. 10, K-LZO (yellow line) does not contain copper. Cu-LZO (red line) contains both copper and the same amount of the potassium in the K-LZO material. FIG. 10 shows that addition of copper drastically increased absorption of CO₂ above 550° C., especially 600-700° C.

In one embodiment, a composition for separating carbon dioxide gas is disclosed. The composition comprises a zirconyl (IV) nitrate; a lithium nitrate; a copper (II) nitrate, and a potassium nitrate, wherein the lithium nitrate is present in a molar ratio between 1 and 3 to the zirconyl (IV) nitrate, the copper (II) nitrate is present in a molar ratio between 0.01 and 0.5 to the zirconyl (IV) nitrate, and the potassium nitrate is present in a molar ratio between 0.1 and 0.5 to the zirconyl (IV) nitrate.

A method of forming a copper infused lithium zirconate for capturing carbon dioxide gas is disclosed. The method comprises mixing a zirconyl (IV) nitrate; a lithium nitrate; a copper (II) nitrate, and a potassium nitrate in a solvent to form a paste, wherein the lithium nitrate is present in a molar ratio between 1 and 3 to the zirconyl (IV) nitrate, the copper (II) nitrate is present in a molar ratio between 0.01 and 0.5 to the zirconyl (IV) nitrate, and the potassium nitrate is present in a molar ratio between 0.1 and 0.5 to the zirconyl (IV) nitrate; drying the paste at a first pressure; and calcining the paste with a heating ramp rate of 10° C. per minute for 0.5-3.0 hours to form the copper infused lithium zirconate.

In some embodiments, the solvent is an alcohol. The alcohol is methanol, ethanol, isopropanol, or butanol. In some certain embodiments, the solvent is an ethanol.

In some embodiments, the paste is dried at 700 to 900° C. In some certain embodiments, the paste is dried at 700 to 900° C. under 0.1 MPa. 0.1 MPa is an atmospheric pressure. In some embodiments, the first pressure is an atmospheric pressure. In some certain embodiments, the first pressure is 0.1 MPa.

In one embodiment, the lithium nitrate is present in a molar ratio between 1 and 3 to the zirconyl (IV) nitrate. In some embodiments, the lithium nitrate is present in a molar ratio between 2.0 and 2.5 to the zirconyl (IV) nitrate. In some embodiments, the lithium nitrate is present in a molar ratio of 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0 to the zirconyl (IV) nitrate.

In one embodiment, the copper (II) nitrate is present in a molar ratio between 0.01 and 0.5 to the zirconyl (IV) nitrate. In some embodiments, the copper (II) nitrate is present in a molar ratio between 0.01 and 0.1 to the zirconyl (IV) nitrate. In some embodiments, the copper (II) nitrate is present in a molar ratio of 0.01, 0.02, 0.03, 0.04, 0.05, 0.06, 0.07, 0.08, 0.09, or 0.10 to the zirconyl (IV) nitrate. In some certain embodiments, the copper (II) nitrate is present in a molar ratio of 0.08 to the zirconyl (IV) nitrate.

In one embodiment, and the potassium nitrate is present in a molar ratio between 0.1 and 0.5 to the zirconyl (IV) nitrate. In some embodiments, the potassium nitrate is present in a molar ratio between 0.15 and 0.25 to the zirconyl (IV) nitrate. In some embodiments, the potassium nitrate is present in a molar ratio of 0.15, 0.16, 0.17, 0.18, 0.19, 0.20, 0.21, 0.22, 0.23, 0.24, or 0.25 to the zirconyl (IV) nitrate.

In some embodiments, a carbon dioxide absorption rate constant of the composition under CO₂ is 1.2 times higher than a lithium zirconate solution at 600° C.

In some embodiments, the carbon dioxide absorption rate constant of the composition under CO₂ is between 1.50×10⁻² and 3.00×10⁻² min⁻¹ at 600° C. In some embodiments, the carbon dioxide absorption rate constant of the composition under CO₂ is between 1.99×10⁻² and 2.45×10⁻² min⁻¹ at 600° C.

In some embodiments, a carbon dioxide absorption rate constant of the composition under CO₂ is 1.5 times higher than a lithium zirconate solution at 700° C. In some embodiments, the carbon dioxide absorption rate constant of the composition under CO₂ is between 2.50×10⁻² and 5.50×10⁻² min⁻¹ at 700° C. In some embodiments, the carbon dioxide absorption rate constant of the composition under CO₂ is between 2.61×10⁻² and 5.16×10⁻² min⁻¹ at 700° C.

In some embodiments, a carbon dioxide absorption rate constant of the composition in CO₂ after exposure to air is 1.2 times higher than a lithium zirconate solution at 600° C. In some embodiments, the carbon dioxide absorption rate constant of the composition in CO₂ after exposure to air is 2.86×10⁻² min⁻¹ at 600° C.

In some embodiments, a carbon dioxide absorption rate constant of the composition in CO₂ after exposure to air is 2.2 times higher than a lithium zirconate solution at 700° C. In some embodiments, the carbon dioxide absorption rate constant of the composition in CO₂ after exposure to air is 7.93×10⁻² min⁻¹ at 700° C. In some embodiments, the carbon dioxide absorption rate constant of the composition in CO₂ after exposure to air is 3.70×10⁻² min⁻¹ at 700° C.

In some embodiments, the composition has a powder X-ray diffraction pattern, which comprises characteristic peaks at a reflection angel 20 of approximately 21.90, 35.71, 39.82, 42.40, 59.56, and 61.58 degrees. Additionally, the composition has a powder X-ray diffraction pattern comprising peaks at a reflection angel 20 of approximately 23.02, 26.57, and 28.18.

A method of separating carbon dioxide gas is disclosed. The method comprises flowing an effluent gas mixture through a membrane, wherein the membrane comprises zirconium (Zr), lithium (Li), potassium (K), and copper (Cu); absorbing the carbon dioxide gas into the membrane at a temperature between 450° C. and 650° C., wherein the membrane absorbs the carbon dioxide at an absorption rate constant between 2.00×10⁻² and 9.00×10⁻² min⁻¹; and desorbing the carbon dioxide gas from the membrane at a temperature above 651° C., wherein the membrane desorbs the carbon dioxide at a desorption rate constant between −1.20×10⁻² and −6.00×10⁻² min⁻¹.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

It is claimed:

1. A composition for separating carbon dioxide gas, comprising:
a zirconyl (IV) nitrate; a lithium nitrate; a copper (II) nitrate, and a potassium nitrate, wherein the lithium nitrate is present in a molar ratio between 1 and 3 to the zirconyl (IV) nitrate, the copper (II) nitrate is present in a molar ratio between 0.01 and 0.5 to the zirconyl (IV) nitrate, and the potassium nitrate is present in a molar ratio between 0.1 and 0.5 to the zirconyl (IV) nitrate.

2. The composition of claim 1, wherein the lithium nitrate is present in a molar ratio between 2.0 and 2.5 to the zirconyl (IV) nitrate, the copper (II) nitrate is present in a molar ratio between 0.01 and 0.1 to the zirconyl (IV) nitrate, and the potassium nitrate is present in a molar ratio between 0.15 and 0.25 to the zirconyl (IV) nitrate.

3. The composition of claim 1 or 2, wherein the copper (II) nitrate is present in a molar ratio of 0.08 to the zirconyl (IV) nitrate.

4. The composition of claim 1 or 2, wherein a carbon dioxide absorption rate constant of the composition under CO₂ is 1.2 times higher than a lithium zirconate solution at 600° C.

5. The composition of claim 1 or 2, wherein a carbon dioxide absorption rate constant of the composition under CO₂ is 1.5 times higher than a lithium zirconate solution at 700° C.

6. The composition of claim 1 or 2, wherein the carbon dioxide absorption rate constant of the composition under CO₂ is between 1.99×10⁻² and 2.45×10⁻² min⁻¹ at 600° C.

7. The composition of claim 1 or 2, wherein the carbon dioxide absorption rate constant of the composition under CO₂ is between 2.61×10⁻² and 5.16×10⁻² min⁻¹ at 700° C.

8. The composition of claim 1 or 2, wherein a carbon dioxide absorption rate constant of the composition in CO₂ after exposure to air is 1.2 times higher than a lithium zirconate solution at 600° C.

9. The composition of claim 1 or 2, wherein a carbon dioxide absorption rate constant of the composition in CO₂ after exposure to air is 2.2 times higher than a lithium zirconate solution at 700° C.

10. The composition of claim 1 or 2, wherein the carbon dioxide absorption rate constant of the composition in CO₂ after exposure to air is 2.86×10⁻² min⁻¹ at 600° C.

11. The composition of claim 1 or 2, wherein the carbon dioxide absorption rate constant of the composition in CO₂ after exposure to air is 7.93×10⁻² min⁻¹ at 700° C.

12. The composition of claim 3, wherein the carbon dioxide absorption rate constant of the composition in CO₂ after exposure to air is 3.70×10⁻² min⁻¹ at 700° C.

13. The composition of claim 1, wherein the composition has a powder X-ray diffraction pattern, which comprises characteristic peaks at a reflection angle 20 of approximately 21.9, 35.7, 39.8, 42.4, 59.6, and 61.6 degrees.

14. A method of forming a copper infused lithium zirconate for capturing carbon dioxide gas comprising:
mixing a zirconyl (IV) nitrate; a lithium nitrate; a copper (II) nitrate, and a potassium nitrate in a solvent to form a paste, wherein the lithium nitrate is present in a molar ratio between 1 and 3 to the zirconyl (IV) nitrate, the copper (II) nitrate is present in a molar ratio between 0.01 and 0.5 to the zirconyl (IV) nitrate, and the potassium nitrate is present in a molar ratio between 0.1 and 0.5 to the zirconyl (IV) nitrate;
drying the paste at a first pressure; and
calcining the paste with a heating ramp rate of 10° C. per minute for 0.5-3.0 hours to form the copper infused lithium zirconate.

15. The method of claim 14, wherein the solvent is an alcohol.

16. The method of claim 15, wherein the solvent is an ethanol.

17. The method of any one of claims 14-16, wherein the paste is dried at 700 to 900° C.

18. The method of any one of claims 14-17, wherein the paste is dried at 700 to 900° C. under 0.1 MPa.

19. The method of claim 14, wherein the lithium nitrate is present in a molar ratio between 2.0 and 2.5 to the zirconyl (IV) nitrate, the copper (II) nitrate is present in a molar ratio between 0.01 and 0.1 to the zirconyl (IV) nitrate, and the potassium nitrate is present in a molar ratio between 0.15 and 0.25 to the zirconyl (IV) nitrate.

20. The method of any one of claims 14-19, wherein the copper (II) nitrate is present in a molar ratio of 0.08 to the zirconyl (IV) nitrate.

21. The method of any one of claims 14-19, wherein a carbon dioxide absorption rate constant of the copper infused lithium zirconate under CO₂ is 1.2 times higher than a lithium zirconate solution at 600° C.

22. The method of any one of claims 14-19, wherein a carbon dioxide absorption rate constant of the copper infused lithium zirconate under CO₂ is 1.5 times higher than a lithium zirconate solution at 700° C.

23. The method of any one of claims 14-19, wherein the carbon dioxide absorption rate constant of the copper infused lithium zirconate under CO₂ is between 1.99×10⁻² and 2.45×10⁻² min⁻¹ at 600° C.

24. The method of any one of claims 14-19, wherein the carbon dioxide absorption rate constant of the copper infused lithium zirconate under CO₂ is between 2.61×10⁻² and 5.16×10⁻² min⁻¹ at 700° C.

25. The method of any one of claims 14-19, wherein a carbon dioxide absorption rate constant of the copper infused lithium zirconate in CO₂ after exposure to air is 1.2 times higher than a lithium zirconate solution at 600° C.

26. The method of any one of claims 14-19, wherein a carbon dioxide absorption rate constant of the copper infused lithium zirconate in CO₂ after exposure to air is 2.2 times higher than a lithium zirconate solution at 700° C.

27. The method of any one of claims 14-19, wherein the carbon dioxide absorption rate constant of the copper infused lithium zirconate in CO₂ after exposure to air is 2.86×10⁻² min⁻¹ at 600° C.

28. The method of any one of claims 14-19, wherein the carbon dioxide absorption rate constant of the copper infused lithium zirconate in CO₂ after exposure to air is 7.93×10⁻² min⁻¹ at 700° C.

29. The method of claim 20, wherein the carbon dioxide absorption rate constant of the copper infused lithium zirconate in CO₂ after exposure to air is 3.70×10⁻² min⁻¹ at 700° C.

30. The method of any one of claims 14-29, wherein the first pressure is 0.1 MPa.

31. A method of selectively separating carbon dioxide gas, comprising:
flowing an effluent mixture through a solid state membrane device, wherein the membrane comprises zirconium (Zr), lithium (Li), potassium (K), and copper (Cu);
absorbing the carbon dioxide gas into the membrane at a temperature between 400° C. and 750° C., wherein the membrane absorbs the carbon dioxide at an absorption rate constant between 2.00×10⁻² and 9.00×10⁻² min⁻¹; and
desorbing the carbon dioxide gas from the membrane at a temperature above 651° C., wherein the membrane desorbs the carbon dioxide at a desorption rate constant between −1.20×10⁻² and −6.00×10⁻² min⁻¹.

32. The method of claim 31, wherein the lithium (Li) is present in a molar ratio between 2.0 and 2.5, the potassium (K) is present in a molar ratio between 0.15 and 0.25, and the copper (Cu) is present in a molar ratio between 0.01 and 0.10.
